(19) United States
(12) Patent Application Publication
(10) Pub. No.: US 2007/0200615 A1
(43) Pub. Date: Aug. 30, 2007

(54) Driver Circuit

(76) Inventors: Jan-Erik Eklund, Linkoping (SE); Joakim Alvbrant, Linkoping (SE)

Correspondence Address: BAKER BOTTS, L.L.P., 98 SAN JACINTO BLVD., SUITE 1500, AUSTIN, TX, 78701-4039, US

(21) Appl. No.: 11/680,296

(22) Filed: Feb. 28, 2007

(30) Foreign Application Priority Data
Feb. 28, 2006 (SE) 0600439-4

(51) Int. Cl. G05F 1/10

(52) U.S. Cl. 327/536

(57) ABSTRACT

A driver circuit for powering an electronic device has a voltage source, two charge pump arrangements each having a diode connected in series with a capacitor. The charge pump arrangements are connected to the voltage source and the capacitors are charged, during a first phase, to a positive voltage level approximately equal to the voltage level of the voltage source. Furthermore, a switch is provided for switching the charge pump arrangements to a second phase, whereby they are charged simultaneously, one of the capacitors to a positive voltage approximately twice the voltage level provided by the voltage source and another one of the capacitors to a negative voltage level having a magnitude, which is approximately equal to a magnitude of the voltage source. An improved and cost-efficient driver circuit is thereby provided, having only few components.

### RELATED APPLICATION

This application claims priority from Sweden Patent Application No. 0600439-4 which was filed on Feb. 28, 2006, and is incorporated herein by reference in its entirety.

### TECHNICAL FIELD

The invention relates to a driver circuit for powering an electronic device, such as a light emitting diode. The invention also relates to such a method for powering an electronic device.

### BACKGROUND

In portable electronic devices, such as cellular phones and laptop computers, DC-to-DC converters are required to feed different sub-circuits within the electronic device with an appropriate voltage level, most often different than the voltage level provided by a battery of the device. The appropriate voltage level may be higher or lower than the battery voltage.

For example, many portable battery driven electronic devices comprise a colour liquid crystal display (LCD), and a white light emitting diode (LED) is commonly used as background illumination in such colour LCD applications. Some applications, for example DECT (Digital Enhanced Cordless Telecommunications), use a low-voltage supply such as a two-cell NiMH (nickel-metal hydride) instead of a Li-Ion battery (Lithium ion battery), which is commonly used in GSM phones. However, a two-cell NiMH battery only delivers 2 V, while a white LED typically requires a supply voltage of 4-5 V in order to operate properly. An obvious solution would be to add battery cells in order to provide the required voltage. However, the cost and size of a portable electronic device are usually important concerns and adding battery cells adds to the cost as well as the size. The required voltage level of the LED is thus higher than the voltage provided by the battery of the device, and a DC-to-DC converter is therefore needed.

One possible solution is to utilise a DC-to-DC converter that steps up the voltage output from the battery to 3.3 V and then a charge pump is used in order to deliver approximately 5 V. A charge pump is an electronic circuit that uses capacitors as energy storage elements to convert an input DC voltage into the required DC voltage. Briefly, in order to generate a higher voltage a first stage involves a capacitor being connected across a voltage and charged up. In the second stage the capacitor is disconnected from the original charging voltage and reconnected with its negative terminal to the original positive charging voltage, and since a capacitor retains the voltage across it the positive terminal voltage is added to the original and thereby doubling the voltage.

Another possible solution is to utilise a DC-to-DC converter alone, but then a very advanced and expensive DC-to-DC converter would have to be used, increasing the overall cost of an electronic device.

A disadvantage of using a solution comprising a DC-to-DC converter and a charge pump is that the DC-to-DC converter has to handle the high current for the LED. This entails the use of expensive components and even more expensive should a more than doubled voltage be required. There are applications where the LED consumes 40% of the DC-to-DC converter capacity.

Further, charge pumps use switches to control the connection of voltages to the capacitors. The switches used in such low-power applications, for example implemented as transistors, are most often limited to handle loads of approximately 3.6 V. If higher voltages are applied, the switches will break.

It would thus be desirable to be able to provide an improved driver for low-voltage applications, in particular having an improved DC/DC conversion means.

### SUMMARY

According to an embodiment, a driver circuit for powering an electronic device may comprise a voltage source, a first terminal of which is connected to a reference potential at a first node and a second terminal connected to a second node having a potential of the value of said voltage source, two charge pump arrangements each comprising a rectifier connected in series with a capacitor, said charge pump arrangements being connected to the voltage source and the capacitors are arranged to be charged, during a first phase, such that a third node located between the rectifier and capacitor of a first one of said charge pump arrangements obtains approximately a same potential as the second node, and a fourth node located between the rectifier and capacitor of a second one of said charge pump arrangements obtains approximately the same potential as the first node, such that the voltage across the capacitors is approximately equal to the potential difference between the first and second nodes, and switching means for switching said charge pump arrangements from said first phase to a second phase, wherein said charge pump arrangements are arranged to be charged simultaneously during said second phase such that the potential at the third node is approximately twice the potential at the second node, and such that fourth node has a negative potential of approximately equal magnitude as the potential at the second node, to thereby provide a potential difference between the third and fourth nodes of approximately three times the voltage between the first and second nodes.

### BRIEF DESCRIPTION OF THE DRAWINGS

FIG. 1 is a block diagram over a conventional charge pump.

FIG. 2 is a block diagram of an embodiment.

FIGS. 3a- 3b are block diagrams of different phases of the driver circuit of FIG. 2.

FIG. 4 is a block diagram of a simulation model used to verify the embodiments.

FIG. 5 is a simulation result obtained when using the simulation model of FIG. 2.

### DETAILED DESCRIPTION

According to an embodiment, a driver circuit is provided for powering an electronic device. The driver circuit comprises a voltage source, of which a first terminal is connected to a reference potential at a node NO and a second terminal is connected to a node N3 having a potential of the value of the voltage source. According to an embodiment, the driver circuit further comprises two charge pump arrangements each comprising a rectifier connected in series with a capacitor. The charge pump arrangements are connected to the voltage source and the capacitors are arranged to be charged, during a first phase, such that a node N1 located between the rectifier and capacitor of one of the charge pump arrangements obtains approximately a same potential as node N3, and a node N2 located between the rectifier and capacitor of another one of the charge pump arrangements obtains approximately the same potential as node N0, such that the voltage across the capacitors is approximately equal to the potential difference between node N0 and N3. Switching means are provided for switching the charge pump arrangements from the first phase to a second phase, whereby they are arranged to be charged simultaneously during this second phase such that the potential at the node N1 is approximately twice the potential at node N3, and such that node N2 has a negative potential of approximately equal magnitude as the potential at node N3, to thereby provide a potential difference between nodes N1 and N2 of approximately three times the voltage between the node nO and N3. In accordance with the invention, the charge is thus pumped both in +Vᵢₙ and −Vᵢₙ simultaneously and a voltage three times the battery voltage can be obtained. The inventive driver circuit requires very few components and the price and chip area requirement can be kept down, providing a most cost-efficient and small driver circuit. Further, the voltage applied to the switches being used never exceeds the battery voltage applied and switch failures can thereby be avoided.

According to another embodiment, the two charge pump arrangements are connected between the positive and negative connection ends of the voltage source, the switches are arranged to enable connection of the capacitor of the first charge pump arrangement to the negative connection end of the voltage supply and to the positive connection end of the voltage supply so as to charge the capacitor. A first switch is connected between the positive connection end of the voltage source, a third switch and the capacitor of a first charge pump arrangement; a second switch is connected between the capacitor of the first charge pump arrangement, the capacitor of the second charge pump arrangement and the negative connection end of the voltage source; the third switch is connected between the positive connection end of the voltage supply, the capacitor of the first charge pump arrangement and the capacitor of the second charge pump arrangement; a fourth switch is connected between the capacitors of the charge pump arrangements and the negative connection end of the battery; a fifth switch is connected between the diode of the second charge pump arrangement and the second and fourth switches. A simple circuit is thereby implemented having only few components and still enabling an output voltage of three times the voltage of the voltage source used.

According to another embodiment, a load device is provided having one end connected to a node N1 and the other end connected to a node N2, wherein the nodes are the nodes between the diode and capacitor of each charge pump arrangement. This is where the output voltage is triple the voltage of the voltage source, a voltage suitable to drive for example a light emitting diode. Other voltage levels can also be provided, thereby enabling different output voltages by means of a relatively simple and inexpensive circuit.

According to another embodiment, the driver circuit is used for driving light emitting diodes. Such light emitting diodes are commonly used for example for providing a background illumination of a liquid crystal display, and the invention thus provides a cost-efficient solution for use in general applications.

According to another embodiment, one or possibly more light emitting diodes or other electronic devices are connected in series with a respective resistor. Thereby differences in threshold voltages of the light emitting diodes are evened out.

According to another embodiment, the voltage source comprises two nickel-metal hydride cells. Any other voltage source could alternatively be used providing flexibility, but nickel-metal hydride batteries are an adequate choice for, for example, driving a light emitting diode.

In accordance with yet another embodiment, the capacitors and the diodes are arranged off-chip, while the switches are arranged on-chip. A circuit designer is thereby provided with design flexibility in implementing the circuit.

According to an embodiment, in a method for driving a low-power device, the advantages corresponding to the above described are achieved.

In the following description the terms driver and driver circuit are used to denote an electronic component (for instance, an integrated circuit), used to control another electronic component (for instance, a white light emitting diode).

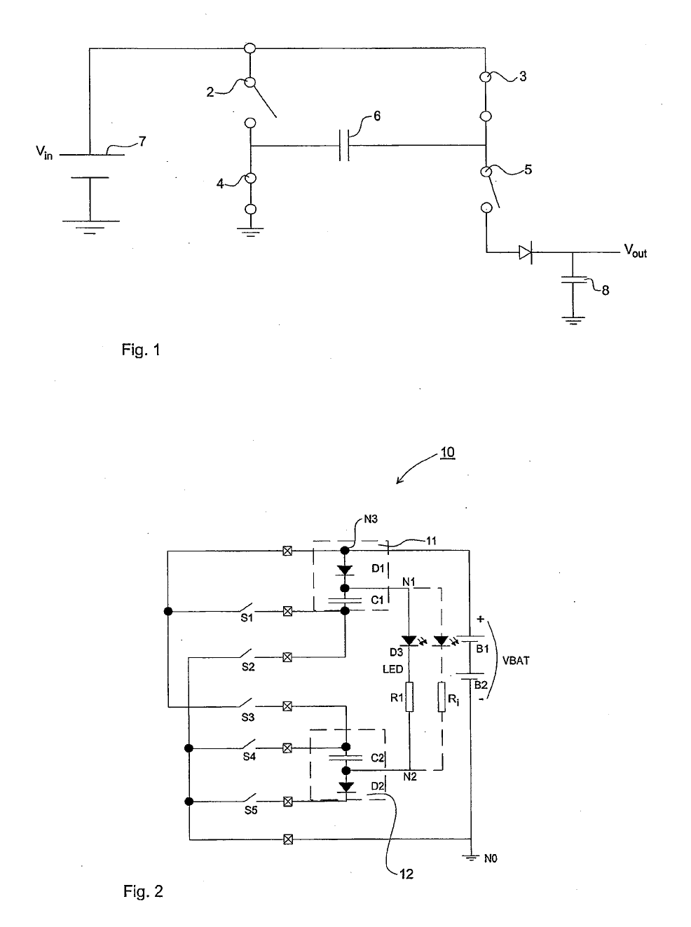

It is difficult to operate a LED directly from a battery, because the discharge state of most batteries is below the LED's minimum-required forward voltage, and hence a charge pump is utilised. In order to facilitate a thorough understanding of the disclosed embodiments the general operation of a charge pump is first briefly described. FIG. 1 is a block diagram illustrating the principle of a charge pump. The circuit 1 comprises a number of switches 2, 3, 4, 5 and at least two capacitors 6, 8, usually called “flying capacitor” or transfer capacitor and “reservoir capacitor”, respectively. The circuit 1 operates in two phases, a charge phase and a transfer phase. During the charge phase, which is illustrated in the figure, the switches 2 and 5 are open and switches 3 and 1 are closed. The battery 7 charges the flying capacitor 6 to the input voltage level, Vᵢₙ. During the transfer phase, 2 and 5 are closed and 3 and 4 are open. The voltage across the capacitor 6 is in series with the input voltage Vin. Both the battery 7 and the capacitor 6 are discharging into the output capacitor 8, and the basic charge pump thus operates as a voltage doubler generating an output voltage of Vₒᵤₜ=2* Vᵢₙ. By adding additional “flying capacitors” and switches multiple voltages can be obtained. However, if several stages of charge pumps are used, in which the voltage input to one of the stages including a diode exceeds a certain voltage, for example the battery voltage, the switch will break, as was mentioned earlier. An oscillator is generally used to control the switches, and the first phase of the clock cycle of the oscillator is used to control the switches in the charge phase, and a second phase of the clock cycle is used to control the switches in the transfer phase.

FIG. 2 is a block diagram of an embodiment. The driver circuit 10 in accordance with the embodiment comprises two charge pump arrangements 11, 12 each comprising a rectifier such as a diode D₁, D₂ connected in series with a capacitor C₁, C₂ as will be described in the following. It is understood that although diodes are used in the description in order to illustrate the embodiment, other rectifier devices may be used, for example comprising one or more semi conductive devices. The driver circuit 10 further comprises a power supply, for example NiMH battery with two cells B₁, B₂ as shown in the figure, able to deliver a voltage V_{bat}, typically approximately 2 V. The voltage between the terminals of the power supply, i.e. between nodes N0 and N3, can have any suitable value. Further, it is realised that other power sources could be used, for example alkaline batteries or nickel-cadmium batteries. In the figure node N0 is shown to be grounded, i.e. having a potential of 0 V, however other reference potentials can of course be used. The actual value of node No is used in order to relate to the potentials at the other nodes, and any value can be used if the reference potential is defined elsewhere. In such case the potentials at the other nodes need of course be recalculated accordingly.

The driver circuit 10 in accordance with the illustrated embodiment further comprises five switches S₁, S₂, S₃, S₄ and S₅, for example semiconductor switches. The periodic switching of the switches S₁, S₂, S₃, S₄, S₅, is preferably accomplished by means of an integrated frequency oscillator (not shown) generating a timing sequence.

The driver circuit 10 further comprises diodes D₁ and D₂ connected to the power source B₁, B₂, and capacitors C₁ and C₂ connected in series with a respective diode D₁, D₂. The diodes D₁ and D₂ are preferably externally placed semiconductor diodes such as Schottky diodes, having a low forward voltage drop and a very fast switching action. In an alternative embodiment the diodes D₁ and D₂ are placed on-chip. Between the diode and capacitor of both diode-capacitor pairs, indicated as nodes N1 and N2, an electronic device can be connected. In the exemplary embodiment of FIG. 1 the electronic device is a light emitting diode (LED) D₃, which is suitable for example for use as background illumination in LCD's. In the following the LED D₃ is used as illustration, but it is realised that any electronic device could be connected between nodes N1 and N2, for example a radio transmitter circuit, an electromechanical device or the like requiring a higher voltage.

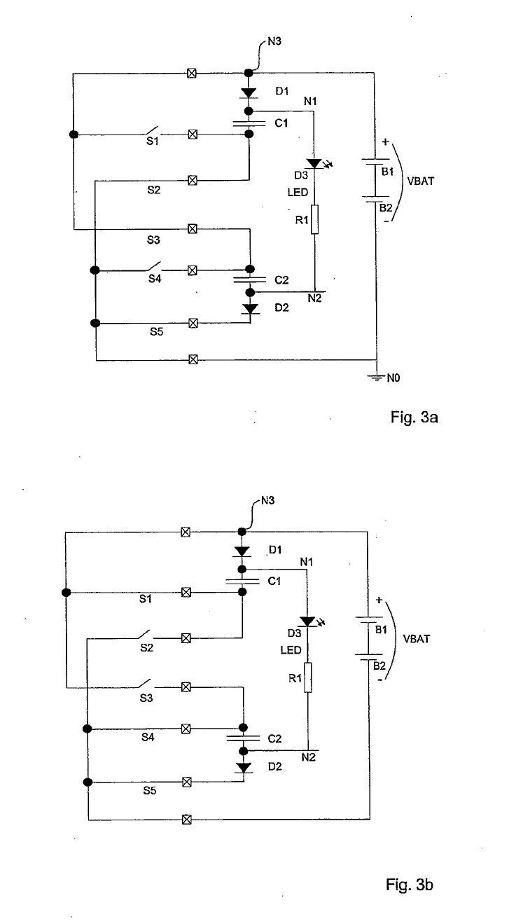

In a first phase, illustrated in FIG. 3a, switches S₂, S₃ and S₅ are conducting while switches S₁, and S₄ are not conducting. If it is assumed that the diodes D₁ and D₂ are conducting as ideal diodes with a zero voltage drop, the capacitors C₁ and C₂ are charged to approximately the source voltage, i.e. the voltage across both capacitors C₁ and C₂ is then V_{bat}. The voltage across the LED D₃ is too low for significant and proper light emission, as the required forward voltages of a white LED is typically about 4 V.

In a second phase, illustrated in FIG. 3b, the switches S₁, S₄ and S₅ are conducting while the switches S₂ and S₃ are not conducting. As the switch S₂ is non-conducting, the capacitor C₁ is connected with its negative terminal to the positive charging voltage V_{bat}, and since a capacitor retains the voltage V_{bat} from the first phase across it, this connection causes the capacitor C₁ to be charged to the doubled positive voltage, i.e. the node N1 is pushed to the voltage 2*V_{bat}.

Simultaneously, as the switch S₄ is non-conducting, the positive side of the charged capacitor C₂ is shifted from +V_{bat} and connected to ground, and thereby changing the reference of the voltage on the positive side of the capacitor C₂, i.e. the node N2 is pushed to the voltage −V_{bat}. The voltage obtainable between nodes N1 and N2, i.e. across the white LED D₃, then ideally becomes 2*V_{bat}−(−V_{bat})=3*V_{bat}. The voltage across D₃ is now high enough for light emission, and the capacitors C₁ and C₂ are discharged through the LED D₃. A resistor R₁ is preferably provided in order to limit the current through the LED D3.

It is realised that there are losses in a circuit and the potentials at the nodes N1 and N2 are approximately equal to 2*V_{bat} and −V_{bat}, respectively. Thus, the term “approximately equal to” a certain potential is used in order to take losses in the rectifier and switches into account.

In most cases a single white LED is not sufficient for illumination and several LED's thus has to be operated together. In an alternative embodiment several parallel LED devices are therefore used; one such additional LED device is indicated in FIG. 2 with dashed lines, comprising a LED Dᵢ and a resistor Rᵢ. Each branch preferably has a resistor Rᵢ connected in series with the respective LED Dᵢ, whereby the resistors R₁, . . . , R₁, . . . , Rₙ evens out the differences in threshold voltages, i.e. the forward voltage required, in the n parallel devices. Such differences in threshold voltages can for example occur due to differences in the size of the LED, the process to manufacture the LED and the temperature of the LED in a respective light source. Ideally, the same current is fed through all LED's connected in parallel so that all LEDs have the same brightness, whereby an even illumination can be provided.

The switch S₅ is not required for the charge pump function, but the signal path through D₁, D₃ and D₂ has to be switched off and this is preferably accomplished by means of the switch S₅. In another embodiment the switch S₅ may be omitted, but then there may be some power consumption, the LED may for example light a little.

The current through a LED is sensitive to the battery voltage and a change in operating voltage caused by battery discharges may change the colour and intensity, since a change in operating voltage changes the forward current. Therefore, some means for handling the varying voltages may preferably be included. For example, current limiters could be added at switch S₄ and/or switch S₁ (not shown). Alternatively, the battery voltage could be measured with an on-chip battery measurement unit and any voltage change could be compensated for by adjusting the pumping frequency of the oscillator.

In FIG. 2, the framed crosses indicate pads of a chip, and as shown, the switches are preferably internal components placed on chip, while the diodes and capacitors are placed off chip. The size of the capacitors needed is generally too big for standard IC (Integrated Circuit) technology. Further, the voltage at the nodes N1 and N2 are typically too high for IC technology.

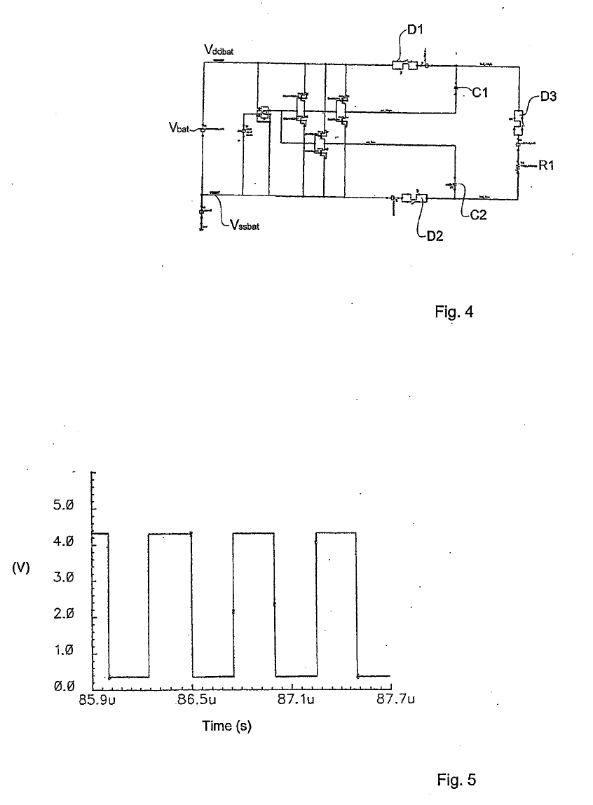

FIG. 4 is a block diagram of a simulation model used for verifying the embodiments, in which same reference numerals as used in FIG. 2 indicate corresponding elements. A single LED was used in the simulation.

FIG. 5 is a graph of simulation results obtained when performing the simulations in accordance with the simulation model of FIG. 4. The y-axis represents the voltage across node N1-N2, and the x-axis represents a time scale. The results showed that the voltage obtained across LED D₃ was approximately 4.1 V when a 2 V battery source was utilized.

The driver circuit in accordance with an embodiment thus comprises a voltage source, two charge pump arrangements and switching means. Each charge pump arrangement comprises a rectifier, for example a diode, connected in series with a capacitor and the charge pump arrangements are connected to the voltage source. The capacitors are arranged to be charged, during a first phase, to a positive voltage level approximately equal to the voltage level of the voltage source. The switching means are provided for switching the charge pump arrangements from the first phase to a second phase, whereby the charge pump arrangements are arranged to be charged simultaneously during the second phase. One of the capacitors is charged to a positive voltage approximately twice the voltage level provided by the voltage source, and the other one of the capacitors is charged to a negative voltage level having a magnitude, which is approximately equal to a magnitude of the voltage source. Thereby a voltage difference is provided between the capacitors of approximately three times the voltage level of the voltage source.

In summary, the present invention provides an improved driver circuit for low-power applications. In accordance with the invention the charge is pumped in both directions, i.e. +Vᵢₙ and −Vᵢₙ, simultaneously and a voltage three times the battery voltage can be obtained. The inventive driver circuit requires very few components and the price and chip area requirement can be kept down, providing a most cost-efficient and small driver circuit. Further, the voltage applied to the switches being used never exceeds the battery voltage and switch failures can thereby be avoided.

What is claimed is:

1. A driver circuit for powering an electronic device, said driver circuit comprising:
a voltage source, a first terminal of which is connected to a reference potential at a first node and a second terminal connected to a second node having a potential of the value of said voltage source,
two charge pump arrangements each comprising a rectifier connected in series with a capacitor, said charge pump arrangements being connected to the voltage source and the capacitors are arranged to be charged, during a first phase, such that a third node located between the rectifier and capacitor of a first one of said charge pump arrangements obtains approximately a same potential as the second node, and a fourth node located between the rectifier and capacitor of a second one of said charge pump arrangements obtains approximately the same potential as the first node, such that the voltage across the capacitors is approximately equal to the potential difference between the first and second nodes, and
switching means for switching said charge pump arrangements from said first phase to a second phase, wherein said charge pump arrangements are arranged to be charged simultaneously during said second phase such that the potential at the third node is approximately twice the potential at the second node, and such that fourth node has a negative potential of approximately equal magnitude as the potential at the second node, to thereby provide a potential difference between the third and fourth nodes of approximately three times the voltage between the first and second nodes.

2. The driver circuit as claimed in claim 1, wherein said two charge pump arrangements are connected between the positive and negative connection ends of the voltage source, switches are arranged to enable connection of the capacitor of the first charge pump arrangement to the negative connection end of the voltage supply and to the positive connection end of the voltage supply so as to charge said capacitor, wherein a first switch is connected between the positive connection end of the voltage source, a third switch and the capacitor of a first charge pump arrangement; a second switch is connected between the capacitor of the first charge pump arrangement, the capacitor of a second charge pump arrangement and the negative connection end of the voltage source; the third switch is connected between the positive connection end of the voltage supply, the capacitor of the first charge pump arrangement and the capacitor of the second charge pump arrangement; a fourth switch is connected between the capacitors of the charge pump arrangements and the negative connection end of the battery.

3. The driver circuit as claimed in claim 2, further comprising a fifth switch connected between a rectifier of the second charge pump arrangement and the second and fourth switches.

4. The driver circuit as claimed in claim 1, further comprising a load device having one end connected to the third node and the other end connected to the fourth node, said third and fourth nodes being the nodes between the rectifier and capacitor of each charge pump arrangement.

5. The driver circuit as claimed in claim 4, wherein said electronic device is a light emitting diode.

6. The driver circuit as claimed in claim 5, wherein said light emitting diode is connected in series with a resistor.

7. The driver circuit as claimed in claim 4, wherein two or more light emitting diodes are connected in parallel between said nodes.

8. The driver circuit as claimed in claim 4, wherein the one or more light emitting diodes are connected in series with a respective resistor, whereby differences in threshold voltages of the light emitting diodes are evened out.

9. The driver circuit as claimed in claim 1, wherein said voltage source comprises two nickel-metal hydride cells.

10. The driver circuit as claimed in claim 1, wherein said capacitors and said rectifiers are arranged off-chip, while said switches are arranged on-chip.

11. A method for powering an electronic device by means of a driver circuit comprising a voltage source having a first terminal connected to a first node and a second terminal connected to a second node having a potential of the value of the voltage source, the method comprising the steps of:
charging, during a first phase, two charge pump arrangements each comprising a rectifier connected in series with a capacitor, such that a third node located between the rectifier and capacitor of one of the charge pump arrangements obtains approximately a same potential as the second node, and a fourth node located between the rectifier and capacitor of another one of the charge pump arrangements obtains approximately the same potential as the first node, such that the voltage across the capacitors is approximately equal to the potential difference between the first and second nodes, said charge pump arrangements being connected between the first and second terminals of the voltage source,
switching, by switching means, from said first phase to a second phase, and
charging simultaneously, during said second phase, said charge pump arrangements, such that the potential at the node N1 is approximately twice the potential at the second node, and such that the fourth node has a negative potential of approximately equal magnitude as the potential at second node, to thereby provide a potential difference between the third and fourth nodes of approximately three times the voltage between the first and second node.

12. A driver circuit for powering an electronic device, said driver circuit comprising a voltage source having a voltage V_{bat}, comprising:
two charge pump arrangements each comprising a rectifier connected in series with a capacitor, said charge pump arrangements being connected to the voltage source and the capacitors are arranged to be charged, during a first phase, to V_{bat}, and
switching means for switching said charge pump arrangements from said first phase to a second phase, whereby said charge pump arrangements are arranged to be charged simultaneously during said second phase, one of the capacitors to 2*V_{bat} and another one of the capacitors to −V_{bat}, to thereby provide a voltage difference between the capacitors of approximately 3*V_{bat}.
